(19) United States
(12) Patent Application Publication
(10) Pub. No.: US 2011/0252125 A1
(43) Pub. Date: Oct. 13, 2011

(54) Dynamic Syncing

(75) Inventors: David Tse, Kirkland, WA (US); Peter Baer, Bothell, WA (US)

(73) Assignee: Microsoft Corporation, Redmond, WA (US)

(21) Appl. No.: 12/757,062

(22) Filed: Apr. 9, 2010

(51) Int. Cl. G06F 15/173; G06F 15/16

(52) U.S. Cl. 709/224; 709/248

(57) ABSTRACT

Dynamic syncing may be provided. A server may be polled in a baseline mode for changes to a file. This baseline polling may comprise polling the server for changes to the file periodically at a first period. In addition, the server may be polled in an overdrive mode for changes to the file when polling the server in the baseline mode for changes to the file detects that changes have been made to the file. Polling the server in the overdrive mode may comprise polling the server for subsequent changes to the file periodically at a second period smaller that the first period and then at subsequent consecutively longer periods until one of the following occurs: i) a subsequent change to the file is detected; and ii) a subsequent consecutive longer period is greater than or equal to the first period.

### BACKGROUND

Software packages are available for free-form information gathering and multi-user collaboration. While these software packages are most commonly used on laptops or desktop PCs, they have additional features for use on pen-enabled Tablet PCs, or in environments where pen, audio, or video notes are more appropriate than an intensive use of keyboards.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Dynamic syncing may be provided. A server may be polled in a baseline mode for changes to a file. This baseline polling may comprise polling the server for changes to the file periodically at a first period. In addition, the server may be polled in an overdrive mode for changes within the file when polling the server in the baseline mode for changes within the file detects that changes have been found. Polling the server in the overdrive mode may comprise polling the server for subsequent changes within the file periodically at a second period smaller that the first period and then at subsequent consecutively longer periods until one of the following occurs: i) a subsequent change within the file is detected; and ii) a subsequent consecutive longer period is greater than or equal to the first period.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing dynamic syncing; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A multi-user editing system with dynamic syncing may be provided. Consistent with embodiments of the invention, a server may store a file used by multiple clients, each using an application program. Respective multiple users may each be editing a version of the file on their respective clients. As the users make changes, they may need to save their changes to the file and receive any changes that other users may have made. Consequently, the multiple clients may need to synchronize with the file on the server by polling the server for changes within the stored file and pushing out any changes to the file onto the server.

In such a system, there may be competing goals of wanting to keep the user up to date as quickly as possible, but this is balanced against the fact that every request made to poll for changes may incur some cost to the server. In other words, it is desirable to have each client's changes visible to all other clients as quickly as possible, but flooding the server with requests can adversely affect the server. Consequently, embodiments of the invention may balance these two priorities.

Consistent with embodiments of the invention, when a client is not idle (i.e. client is active) a baseline mode synchronization of the file between the client and the server may be performed. For example, an active client may poll the server every 30 seconds to see if any there are any changes within the version of the file on the server. If another client has made a change to the file on the server, for example, it may be likely that other changes to the file on the server will be made soon. Consequently, if the client notices a change to the file on the server, the client may go into an overdrive syncing mode.

The overdrive syncing mode may poll for changes within the file on the server more often than the baseline mode. For example, the overdrive syncing mode may poll for changes within the file on the server at an initial overdrive mode rate (e.g. 5 seconds) as opposed to the slower (e.g. 30 second) baseline mode rate. If no changes within the file on the server are detected, the overdrive syncing mode may gradually move the synchronization rate from the initial overdrive rate back out to the slower baseline mode rate in a gradual way. In other words, if no changes within the file on the server are detected in the overdrive mode, time may be added to the overdrive synchronization rate. For example, 1 second may be added to the 5 second overdrive synchronization rate to take it to 6 seconds. If still no changes within the file on the server are detected, 1 second may be again added to the now 6 second overdrive synchronization rate to take it to 7 seconds and so forth.

This additional time adding may be repeated in the overdrive mode until changes within the file on the server are detected. If changes within the file on the server are detected at any time while in the overdrive mode, the overdrive synchronization rate may be taken back to its initial overdrive mode rate (e.g. 5 seconds.) However, if the synchronization rate in the overdrive mode reaches the synchronization rate of the baseline mode by the aforementioned time adding process, the system may switch back to the baseline mode and the process may be repeated.

If at any time, the application program on the client polling the server for changes within the file goes into the idle state, the synchronization rate may be moved out to an idle synchronization rate that may be greater that the baseline mode's synchronization rate. For example, the idle synchronization rate may comprise 7 minutes. The application program may be considered to be in an idle mode if it has not been used for a predetermined time period. For example, if the application program has been minimized or has not received a key stroke or mouse movement for the predetermined time period, the application program may be considered idle.

Regardless of what mode the application program running on the client is in (e.g. baseline, overdrive, or idle,) when the application program pushes a save out to the file on the server, the file saved on the client may be synchronized at that point (or within about 3 seconds of that point) and may not wait to synchronize based on current mode's the synchronization rate. Any subsequent to synchronizing may be based from this point in time moving forward regardless of the mode.

Consistent with embodiments of the invention, not only may the aforementioned mode switching be based on detected changes within the file, but may also include embodiments where different types of changes within the file may be differentiated. For example, different types of changes may comprise, but are not limited to, recent changes with the last 5 minutes or changes older than 5 minutes. In other words, the heuristics that trigger a more aggressive synchronization rate may be based on the contents of the document, not just on the document changing.

Not only may the transition between modes be dependent on the type of change that was detected as stated above, but the transition, for example, may lead to a number of different “overdrive” modes based on the detected change. For example, some changes may make the application program synchronization a little faster with a slower degradation, some other changes may make the application program synchronization a lot faster with a much more rapid degradation, and some changes may not trigger a more aggressive synchronization at all. In other words, the application program may adjust synchronization rates (e.g. intervals) differently based on the type of change that was detected. One example of this may be to not speed up synchronization if the detected change is more than 10 minutes old. Another example of this may be how changes that are made by the users themselves may reset the synchronization schedule regardless of what synchronization mode the application program is in as stated above.

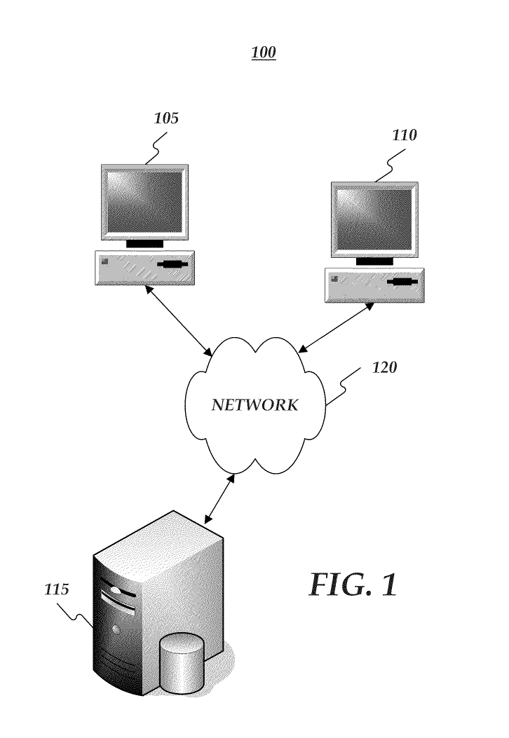

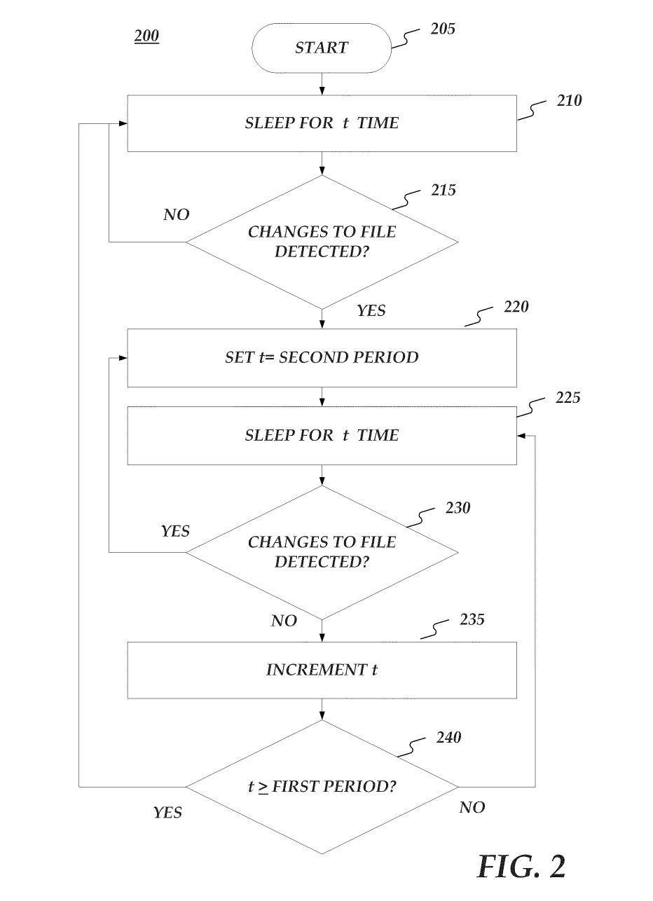

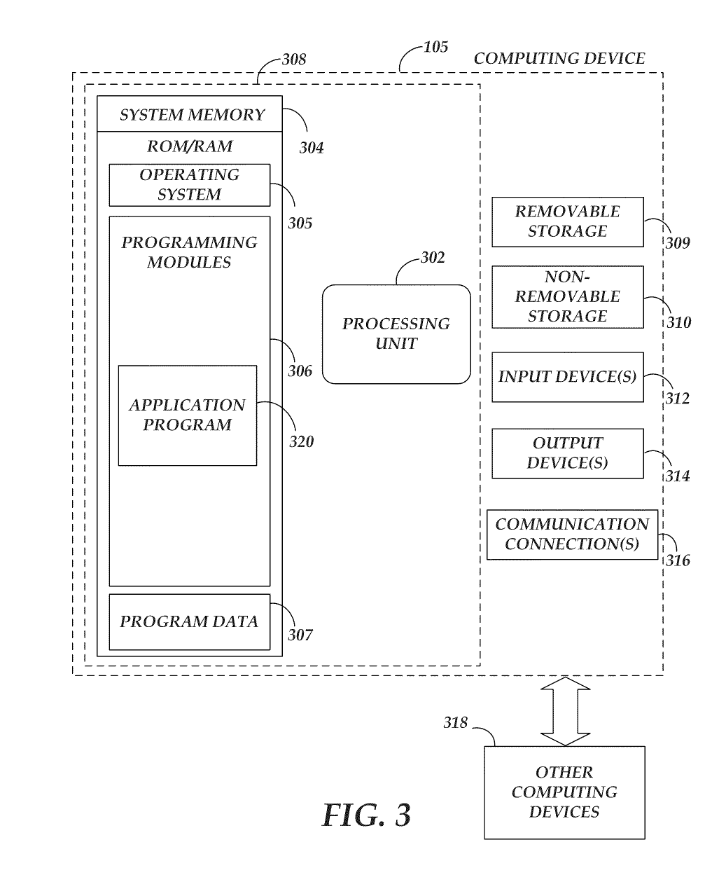

FIG. 1 is a block diagram of an operating environment 100 consistent with embodiments of the invention. As shown in FIG. 1, operating environment 100 may comprise a computing device 105, an other computer 110, a server 115, and a network 120. Computing device 105 and network 120 are described in greater detail below with respect to FIG. 3. Other computer 110 and server 115 may comprise computers similar to computing device 105. Computing device 105 and other computer 110 may be configured to run application programs that read and update a file located on server 115 as described in greater detail below with respect to FIG. 2.

FIG. 2 is a flow chart setting forth the general stages involved in a method 200 consistent with embodiments of the invention for providing dynamic syncing. Method 200 may be implemented using computing device 105 as described above with respect to FIG. 1 and in more detail below with respect to FIG. 3. Ways to implement the stages of method 200 will be described in greater detail below.

Method 200 may begin at starting block 205 and proceed to stage 210 where computing device 105 may poll server 115 at t=a first period. In other words, computing device 105 may sleep for t=first period before server 115 is polled. For example, server 115 may store a file used by multiple clients (e.g. computing device 105 and other computer 110,) each using an application program (e.g. an application program 320 as described in greater detail below with respect to FIG. 3.) Respective multiple users may each be editing a version of the file on their respective clients. As the users make changes, they may need to save their changes to the file and receive any changes that other users may have made. Consequently, the multiple clients may need to synchronize with the file on server 115 by polling server 115 for changes within the stored file and pushing out any changes to the file on server 115.

Consistent with embodiments of the invention, when application program 320, running on computing device 105, is not idle (i.e. client is active) the baseline mode synchronization of the file between computing device 105 and server 115 may be performed. For example, computing device 105 may poll server 115 every t seconds (i.e. first period) to see if other computer 110 has made changes within the version of the file on server 115. First period may comprise, but is not limited to, 30 seconds.

From stage 210, where computing device 105 poles server 115, method 200 may advance to decision block 215 where computing device 105 may determine if changes have been made within the file. For example, if computing device 105 determines that no changes have been made within the file, method 200 may advance back to stage 210 where computing device 105 may continue to poll server 115 at t=first period.

If computing device 105 determines, however, that changes have been made within the file, method 200 may advance to stage 220 where computing device 105 may set t=a second period. For example, if other computer 110 has made a change to the file on server 115, it may be likely that other changes to the file on server 115 will be made soon. Consequently, if computing device 105 notices a change to the file on server 115, computing device 105 may go into the overdrive syncing mode by speeding up the syncing rate from t=first period to t=second period. Second period may comprise, but is not limited to, 5 seconds.

Once computing device 105 sets t=second period in stage 220, method 200 may continue to stage 225 where computing device 105 may poll server 115 at t=second period. In other words, computing device 105 may sleep for t time before server 115 is polled. For example, the overdrive syncing mode may poll for changes to the file on server 115 more often than the baseline mode. For example, the overdrive syncing mode may poll for changes to the file on server 115 at an initial overdrive mode rate (e.g. second period) as opposed to the slower (e.g. first period) baseline mode rate.

From stage 225, where computing device 105 poles server 115, method 200 may advance to decision block 230 where computing device 105 may determine if changes have been made within the file. If computing device 105 determines that changes have been made within the file at decision block 230, method 200 may advance back to stage 220 where computing device 105 may set t=second period. For example, if computing device 105 determines that there are changes, computing device 105 may continue to poll server 115 for changes at the faster overdrive rate. In other words, if changes within the file on server 115 are detected while in the overdrive mode, the overdrive synchronization rate may be taken back to its initial overdrive mode rate.

If computing device 105 determines at decision block 230, however, no changes within the file, method 200 may advance to stage 235 where computing device 105 may increment t. For example, if no changes within the file on server 115 are detected in the overdrive mode, the overdrive syncing mode may gradually move the synchronization rate from the initial overdrive rate back out to the slower baseline mode rate. In other words, if no changes within the file on server 115 are detected in the overdrive mode, time may be added to the overdrive synchronization rate. For example, 1 second may be added to the 5 second overdrive synchronization rate to take it to 6 seconds. If still no changes within the file on server 115 are detected at decision block 230, 1 second may be again added at stage 235 to the now 6 second overdrive synchronization rate to take it to 7 seconds and so forth. This additional time adding may be repeated in the overdrive mode until changes within the file on server 115 are detected at decision block 230.

After computing device 105 increments t in stage 235, method 200 may proceed to decision block 240 where computing device 105 may determine if t is greater than or equal to the first period. If computing device 105 determines at decision block 240 that t is greater than or equal to the first period, method 200 may proceed back to stage 210 where computing device 105 may continue to poll server 115 at t=first period. For example, if the synchronization rate in the overdrive mode is incremented to and reaches the synchronization rate of the baseline mode, the system may switch back to the baseline mode and the process may be repeated. If computing device 105 determines at decision block 240, however, that t is still less than the first period, method 200 may advance back to stage 225 where computing device 105 may poll server 105 at the incremented t value.

If at any time, application program 320 on computing device 105 goes into the idle state, the synchronization rate may be moved out to an idle synchronization rate that may be greater that the baseline mode's synchronization rate. For example, the idle synchronization rate may comprise, but is not limited to, 7 minutes. Application program 320 may be considered to be in the idle state if it has not been used for a predetermined time period. For example, if the application program has been minimized or has not received a key stroke or mouse movement for the predetermined time period, application program 320 may be considered idle.

Regardless of what mode application program 320 is in (e.g. baseline, overdrive, or idle,) when application program 320 pushes a save out to the file on server 115, the file from computing device 105 may be synchronized with server 115 at that point (or within about 3 seconds of that point) and may not wait to synchronize based on current mode's the synchronization rate. Any subsequent to synchronizing may be based from this point in time moving forward regardless of the mode.

FIG. 3 is a block diagram of a system including computing device 105. Consistent with an embodiment of the invention, the aforementioned memory storage and processing unit may be implemented in a computing device, such as computing device 105 of FIG. 3. Any suitable combination of hardware, software, or firmware may be used to implement the memory storage and processing unit. For example, the memory storage and processing unit may be implemented with computing device 105 or any of other computing devices 318, in combination with computing device 105. The aforementioned system, device, and processors are examples and other systems, devices, and processors may comprise the aforementioned memory storage and processing unit, consistent with embodiments of the invention.

With reference to FIG. 3, a system consistent with an embodiment of the invention may include a computing device, such as computing device 105. In a basic configuration, computing device 105 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a program data 307. Operating system 305, for example, may be suitable for controlling computing device 105's operation. In one embodiment, programming modules 306 may include, for example, application program 320. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 105 may have additional features or functionality. For example, computing device 105 may also include additional data storage devices (removable and/or non-removable) such as, for example, magnetic disks, optical disks, or tape. Such additional storage is illustrated in FIG. 3 by a removable storage 309 and a non-removable storage 310. Computing device 105 may also contain a communication connection 316 that may allow device 105 to communicate with other computing devices 318, such as over a network in a distributed computing environment, for example, an intranet or the Internet. Communication connection 316 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 105. Any such computer storage media may be part of device 105. Computing device 105 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 304, including operating system 305. While executing on processing unit 302, programming modules 306 (e.g. application program 320) may perform processes including, for example, one or more method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing dynamic syncing, the method comprising:
polling a server in a baseline mode for changes to a file wherein polling the server in the baseline mode for changes to the file comprises polling the server for changes to the file periodically at a first period; and
polling the server in an overdrive mode for changes to the file when polling the server in the baseline mode for changes to the file detects that changes have been made to the file wherein polling the server in the overdrive mode comprises,
polling the server for subsequent changes to the file periodically at a second period smaller that the first period and then at subsequent consecutively longer periods until one of the following occurs:
a subsequent change to the file is detected, and
a subsequent consecutive longer period is one of: greater than the first period and equal to the first period.

2. The method of claim 1, wherein polling the server in a baseline mode comprises polling the server for changes to the file periodically at the first period comprising approximately 30 seconds.

3. The method of claim 1, wherein polling the server for subsequent changes to the file periodically at the second period comprises polling the server for subsequent changes to the file periodically at the second period comprising approximately 5 seconds.

4. The method of claim 1, wherein polling the server for subsequent changes to the file periodically at the second period smaller that the first period and then at subsequent consecutively longer periods comprises polling the server wherein the subsequent consecutively longer periods are consecutively approximately 1 second longer.

5. The method of claim 1, wherein polling the server in the baseline mode for changes to the file comprises polling the server in the baseline mode for changes to the file comprising a document.

6. The method of claim 1, further comprising enabling polling the server in the baseline mode and polling the server in the overdrive mode when an application program configured to poll the server in the baseline mode and poll the server in the overdrive mode is not idle.

7. The method of claim 1, wherein when polling in the overdrive mode, the method further comprises:
updating the file, and
moving a next subsequent consecutive longer period in time to be substantially concurrent with updating the file.

8. A computer-readable medium that stores a set of instructions which when executed perform a method for providing dynamic syncing, the method executed by the set of instructions comprising:
determining when an application program is not idle;
polling, in response to determining that the application program is not idle, a server in a baseline mode for changes to a file wherein polling the server in the baseline mode for changes to the file comprises polling the server for changes to the file periodically at a first period; and
polling the server in an overdrive mode for changes to the file when polling the server in the baseline mode for changes to the file detects that changes have been made to the file wherein polling the server in the overdrive mode comprises,
polling the server for subsequent changes to the file periodically at a second period smaller that the first period and then at subsequent consecutively longer periods until one of the following occurs:
a subsequent change to the file is detected, and
a subsequent consecutive longer period is one of: greater than the first period and equal to the first period.

9. The computer-readable medium of claim 8, wherein polling the server in a baseline mode comprises polling the server for changes to the file periodically at the first period comprising approximately 30 seconds.

10. The computer-readable medium of claim 8, wherein polling the server for subsequent changes to the file periodically at the second period comprises polling the server for subsequent changes to the file periodically at the second period comprising 5 seconds.

11. The computer-readable medium of claim 8, wherein polling the server for subsequent changes to the file periodically at the second period smaller that the first period and then at subsequent consecutively longer periods comprises polling the server wherein the subsequent consecutively longer periods are consecutively 1 second longer.

12. The computer-readable medium of claim 8, wherein polling the server in the baseline mode for changes to the file comprises polling the server in the baseline mode for changes to the file comprising a document.

13. The computer-readable medium of claim 8, wherein when polling in the overdrive mode, the method further comprises:
updating the file, and
moving a next subsequent consecutive longer period in time to be substantially concurrent with updating the file.

14. A system for providing dynamic syncing, the system comprising:
a memory storage; and
a processing unit coupled to the memory storage, wherein the processing unit is operative to:
determine when an application program is not idle;
pole, in response to determining that the application program is not idle, a server in a baseline mode for changes to a file wherein polling the server in the baseline mode for changes to the file comprises polling the server for changes to the file periodically at a first period; and
poll the server in an overdrive mode for changes to the file when polling the server in the baseline mode for changes to the file detects that changes have been made to the file wherein polling the server in the overdrive mode comprises,
poll the server for subsequent changes to the file periodically at a second period smaller that the first period and then at subsequent consecutively longer periods until one of the following occurs:
a subsequent change to the file is detected, and
a subsequent consecutive longer period is one of: greater than the first period and equal to the first period.

15. The system of claim 14, wherein the first period comprises approximately 30 seconds.

16. The system of claim 14, wherein the second period comprises approximately 5 seconds.

17. The system of claim 14, wherein the processing unit being operative to poll the server for subsequent changes to the file periodically at the second period smaller that the first period and then at subsequent consecutively longer periods comprises the processing unit being operative to poll the server wherein the subsequent consecutively longer periods are consecutively approximately 1 second longer.

18. The system of claim 14, wherein the processing unit being operative to poll the server in the baseline mode for changes to the file comprises the processing unit being operative to poll the server in the baseline mode for changes to the file comprising a document.

19. The system of claim 14, wherein the processing unit being operative to poll in the overdrive mode, comprises the processing unit being operative to:
update the file, and
move a next subsequent consecutive longer period in time to be substantially concurrent with updating the file.

20. The system of claim 14, wherein the processing unit being operative to poll in the overdrive mode, comprises the processing unit being operative to:
update the file, and
move a next subsequent consecutive longer period in time to within approximately 3 seconds of updating the file.
